(19) United States
(12) Patent Application Publication
(10) Pub. No.: US 2003/0120982 A1
(43) Pub. Date: Jun. 26, 2003

(54) Zero-skew transition detection circuit

(76) Inventors: Howard L. Levy, Cedar Park, TX (US); Harsh D. Sharma, Austin, TX (US); Nayon Tomsio, Austin, TX (US)

Correspondence Address: ZAGORIN O'BRIEN & GRAHAM LLP, 401 W 15TH STREET, SUITE 870, AUSTIN, TX, 78701, US

(21) Appl. No.: 10/028,233

(22) Filed: Dec. 21, 2001

(51) Int. Cl. G06K 5/04; G11B 20/20

(52) U.S. Cl. 714/700

(57) ABSTRACT

The present invention describes a method and an apparatus for zero skew signal transition detection between multiple communication paths. The signal transition at the transition point is detected by sampling the signal before the transition point. A transition detection pulse is generated when the signal begins to transition at the transition point. The transition detection pulse can be used to adjust the signal transition on multiple adjacent parallel paths with zero skew to obtain desired coupling between the paths. The width of transition detection pulse can be adjusted to match the transition period of the signal.

### BACKGROUND OF THE INVENTION

1. Field of the Invention

This invention relates to a method and system for reducing or eliminating interference between paths in a communication network, in particular an electronic circuit.

2. Description of the Related Art

Communication networks, in particular communication networks on integrated circuits, have numerous paths carrying signals between signal endpoints. Paths that are placed near one another can lead to problems related to coupling and capacitative interference. The situation becomes most problematic when a first path and a second path run adjacent and parallel to each other and a first signal on the first path transitions or switches at the same time as a second signal on the second path especially, when both signals switch or transition in opposite directions. Coupling effects do not have a detrimental effect upon signals that are switching in the same direction.

Coupling effects lead to slower rise times of path signals. To compensate for slower rise times, path driver power is increased. Path drivers are required to provide additional power to compensate for a slower rise time in order to get signals out and to achieve proper signal level and timing requirements. In certain designs, neutral paths such as ground paths, also known as shield lines, are available and placed between paths, effectively shielding the opposite switching paths from one another. Shield lines typically serve no function but are merely used to shield the paths. The use of neutral paths or shield lines also leads to design considerations and network architecture constraints in laying out paths. Adding shield lines further adds to an increase in the space of the network. In an integrated circuit, minimizing size is highly desirable, and adding non-functional shield lines becomes counter productive to meeting the goal of minimizing size.

A method and apparatus is needed to detect signal transition with zero skew to introduce delay in simultaneous signal transition and reduce and eliminate coupling and capacitative interference.

### SUMMARY

The present invention describes a method of detecting a transition with zero skew. The method includes identifying a coupling point for multiple communication paths, sampling a first communication path of the multiple communication paths at a sampling point on the first communication path, detecting transition of a first signal on the first communication path, and using the transition of the first signal to generate a detection pulse. According to an embodiment of the present invention, the multiple communication paths are parallel adjacent communication paths. The method further includes adjusting the delay of a delay unit to adjust a width of the detection pulse. The method further includes adjusting a first delay for the switching circuit to adjust the width of the detection pulse. The method further includes using the detection pulse to adjust a second delay in a second signal simultaneously transitioning on at least one of the multiple communication paths at the coupling point

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and numerous objects, features, and advantages made apparent to those skilled in the art by referencing the accompanying drawing.

FIG. 1 illustrates an example of a zero skew transition detection system according to an embodiment of the present invention.

FIG. 2 illustrates an example of a zero skew transition detection circuit according to an embodiment of the present invention.

FIG. 3 illustrates an example of steps performed during the process of zero skew transition detection according to an embodiment of the present invention.

FIG. 4 illustrates an example of steps a circuit performs during a process of zero skew transition detection according to an embodiment of the present invention.

### DETAILED DESCRIPTION OF THE INVENTION

The following is intended to provide a detailed description of an example of the invention and should not be taken to be limiting of the invention itself. Rather, any number of variations may fall within the scope of the invention which is defined in the claims following the description.

Introduction

The present invention describes a method and an apparatus for zero skew signal transition detection between multiple communication paths. The signal transition at the transition point is detected by sampling the signal before the transition point. A transition detection pulse is generated when the signal begins to transition at the transition point. The transition detection pulse can be used to adjust the signal transition on multiple adjacent parallel paths with zero skew to obtain desired coupling between the paths. The width of transition detection pulse can be adjusted to match the transition period of the signal.

Transition Detection System

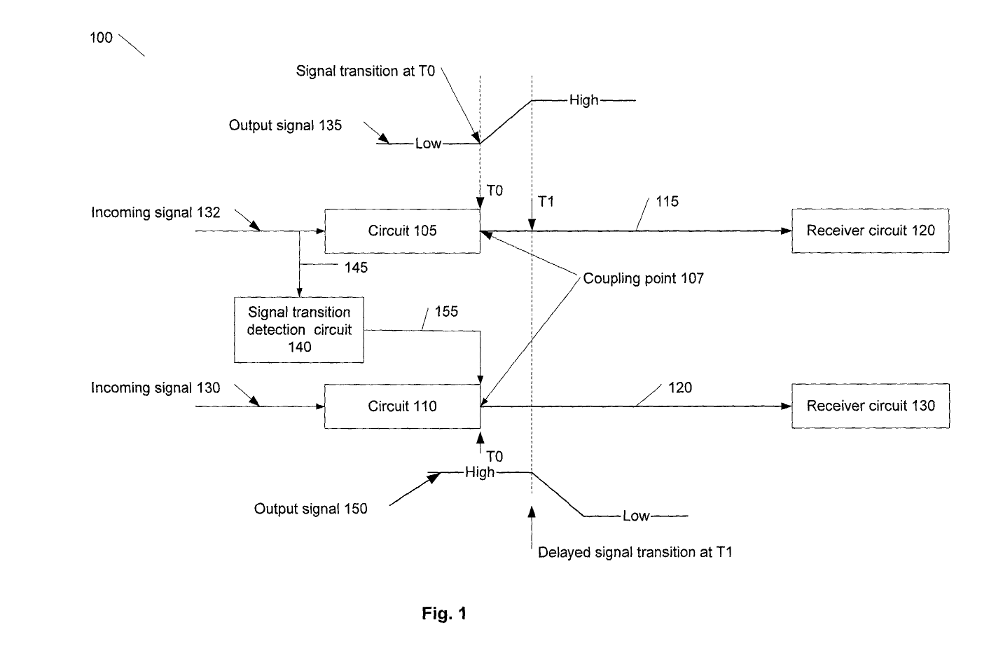

FIG. 1 illustrates an example of a zero skew transition detection system 100 (“system 100”) according to an embodiment of the present invention. For illustration purposes, in the present example, system 100 includes two circuits, circuits 105 and 110. However, it will be apparent to one skilled in the art that system 100 can include multiple circuits. Circuit 105 is coupled via a transmission path 115 to a receiver circuit 120. Circuit 110 is coupled via a transmission path 120 to a receiver circuit 130. Transmission paths 115 and 120 are adjacent and parallel. A simultaneous signal transition on transmission paths 115 and 120 at a coupling point 107 can affect the coupling and capacitative interference between the transmission paths. Circuits 105 and 110 receive an incoming signal 130 as input signal. Circuit 105 processes incoming signal 132, and circuit 110 processes incoming signal 130. Circuit 105 outputs processed signal 135 at coupling point 107. Circuit 110 outputs processed signal 150 at coupling point 107. Processed signal 135 transitions from low to high at coupling point 107 on transmission path 115 at time T0. Simultaneously, processed signal 150 transitions from high to low at coupling point 107 on transmission path 120 at time T0. The transition of processed signal 135 completes at time T1.

A signal transition detection circuit 140 (“detection circuit 140”) is coupled to signal 130 via a transmission path 145. Detection circuit 140 is coupled to circuit 110 via a transmission path 155. Detection circuit 140 detects the transition in signal 130 via transmission path 145 and generates a detection pulse at transmission path 155. The detection pulse can be used to delay the transition of processed signal 150 at coupling point 107. In the present example, the detection pulse is used to delay the transition of processed signal 150 at coupling point 107. The delay in detection circuit 140 can be adjusted to adjust the width of the detection pulse. In the present example, the width of the detection pulse is equal to the transition period of processed signal 135. Processed signal 150 transitions on transmission path 120 after processed signal 135 stabilizes at coupling point on transmission path 115 at time T1. Thus, the coupling and capacitative interference between transmission paths 115 and 120 can be eliminated.

Signal Transition Detection Circuit

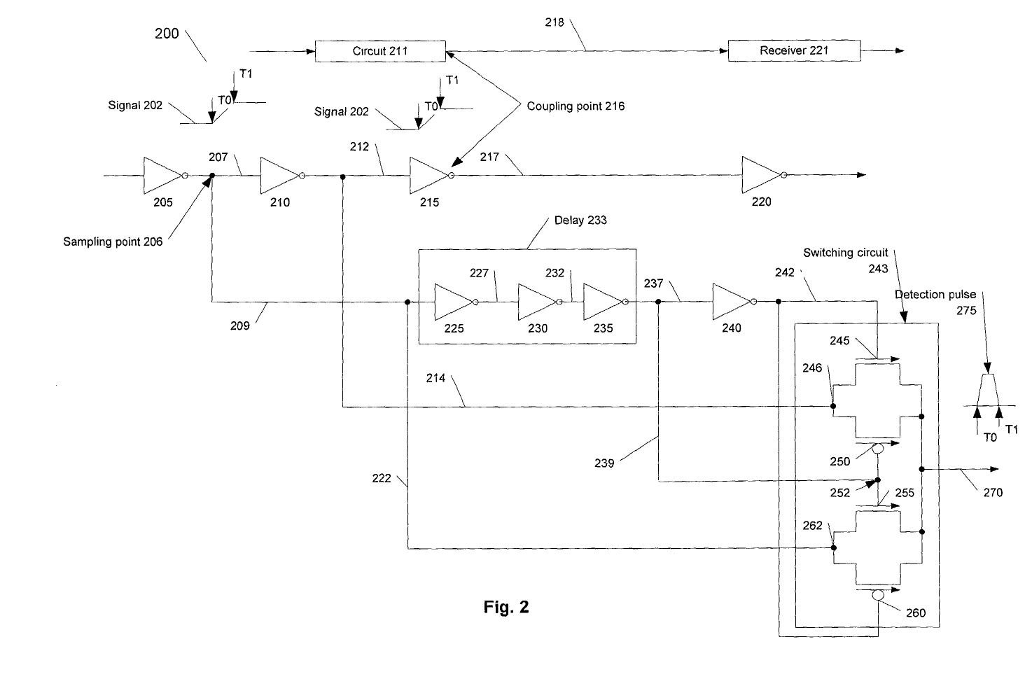

FIG. 2 illustrates an example of a zero skew transition detection circuit 200 according to an embodiment of the present invention. For purposes of illustration, in the present example, inverters (e.g., in a semiconductor chip) are used as signal-processing devices however, any kind of devices (i.e., e.g., buffers, gates, nodes, gate arrays or the like) can be used for signal processing. Devices 205, 210 and 215 form a signal processing circuit such as circuit 105 of FIG. 1. Device 205 is coupled to device 210 via path 207. Device 210 is coupled to device 215 via path 212. The output of device 215 represents the output of signal processing circuit such as circuit 105 in FIG. 1. Another signal processing circuit 211 is coupled to a receiver 221 via a path 218. Paths 217 and 218 are parallel paths. The signal on path 217 experiences the coupling problem at a coupling point 216 similar to signal on path 115 at coupling point 107 in FIG. 1. The signals on paths 217 and 218 transition simultaneously at coupling point 216 thus, creating noise (e.g., coupling, capacitative interference or the like) in the signals. In the present example, path 217 is a critical path and the signal on path 217 is required to transition with minimum interference (e.g., coupling, capacitative or the like).

Device 205 receives a signal 202. Signal 202 is processed by devices 205, 210 and 215. Signal 202 is received by a receiver device 220 on path 217. For purposes of illustrations, in the present example, signal 202 transitions from low to high at the output of device 205, from high to low at the output of device 210 and from low to high at the output of device 215. The signal on path 218 switches from high to low simultaneously. To determine the transition of signal 202 at signal transition point 216, signal 202 is sampled at sampling point 206 on path 209. The sampled signal 202 is processed by a delay circuit 233. Sampling point 206 can be adjusted according to the direction of signal transition and amount of propagation delay needed to generate the detection pulse. Delay circuit 233 includes three devices 225, 230 and 235. The propagation delay of signal 202 through delay circuit 233 can be adjusted by adjusting the number of devices in delay circuit 233. The output of delay circuit 233 is processed by a device 240 to generate appropriate polarity of signal for a switching circuit 243. The input to delay circuit 233 is fed to switching circuit 243.

For illustration purposes, in the present example, switching circuit 243 includes four Metal-Oxide Field-Effect Transistor (MOSFET) devices. However, it will be apparent to one skilled in the art that switching circuit 243 can be configured using any appropriate technology (e.g., bipolar, discrete, other semiconductor devices or the like). The output of switching circuit 243 generates a detection pulse 275 on path 270. The width of detection pulse 275 can be adjusted to be equal to the transition width of signal 202.

Functioning of Signal Transition Detection Circuit

When signal 202 is low at sampling point 206, devices 245 and 250 are off and devices 255 and 260 are on. The output at path 270 is low. When signal 202 begins to transition from low to high at sampling point 206, the input at junction 262 begins to rise and the detection pulse 275 rises accordingly. When signal 202 is stabilized at high value, devices 245 and 250 are turned on and devices 255 and 260 are turned off. When devices 245 and 250 turn on, the input at junction 246, which has already switched from high to low, causes detection pulse 275 to drop from high to low. Detection pulse 275 remains high until devices 245 and 250 are turned on. The delay in turning devices 245 and 250 on is determined by the propagation delay of delay circuit 233. In the present example, the propagation delay of delay circuit 233 is adjusted to be equal to the transition time of signal 202. Thus the width of detection pulse 275 is equal to the transition period of signal 202.

Detection pulse 275 can be used to delay the transition of signal at coupling point 216 for circuit 211. When detection pulse 275 is used to delay the transition of signal at coupling point 216 for circuit 211, the signal on path 218 transitions after the signal on path 217 stabilizes. The critical signal on path 217 transitions without interference (e.g., coupling, capacitative interference or the like) from path 218.

In the present example, sampling point 206 provides enough propagation delay to obtain zero skew between the detection pulse turning on (in the present example, rising) and the transition of the signal at coupling point 216. The location of the sampling point in the circuit can be determined by simulating the signal flows in the circuit. The method of circuit and signal simulation in a device is known in the art. The amount of propagation delay in delay circuit 233 can be adjusted (e.g., by adding or removing devices, defining additional nodes in gate arrays or the like) to adjust the width of detection pulse 275. Detection pulse 275 can be used to remove the coupling interference on multiple paths. In the present configuration, the detection circuit will also detect signal 202 transitioning from a high to low state. The input to junctions 246 and 262 can be configured to cause the detection pulse 275 to transition from high to low when a transition at signal 202 is detected (e.g., switching inputs of junctions 246 and 262). In that type of configuration the detection pulse would be described as a negative pulse as opposed to a positive pulse.

Design Methodology Flow

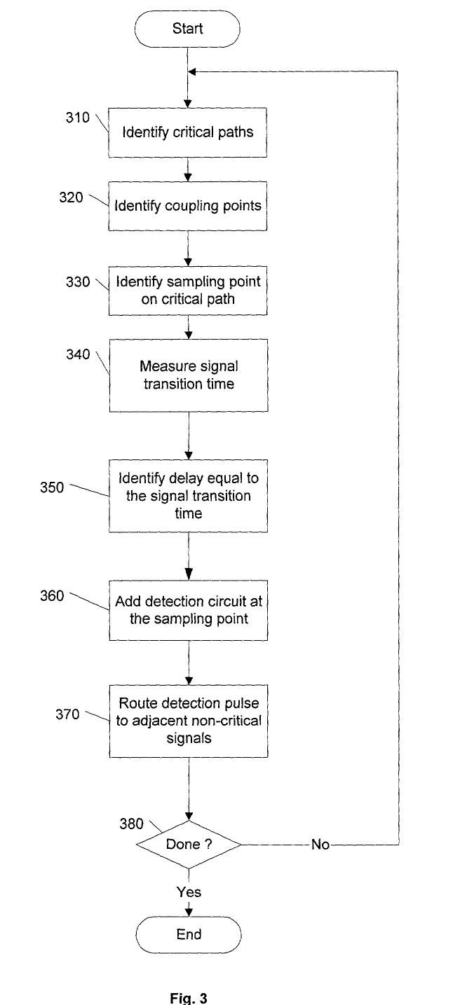

FIG. 3 illustrates an example of steps performed during the design process of zero skew transition detection according to an embodiment of the present invention. Initially, the process identifies the critical paths (310). The critical path is a path that requires signal transition with no interference (noise, capacitative or the like). The process then identifies the coupling point (320). The coupling point is where multiple signals switch simultaneously on multiple communication paths (e.g., in opposite directions) causing signal interference (noise, capacitative or the like). The process identifies the sampling points on the critical path (330).

The sampling point on the critical path can be determined according to the propagation delay between the sampling point and the coupling point. The sampling point can be adjusted to accommodate propagation delays of the detection circuit as described herein. Next, the signal transition time on the critical path is measured (340). The process then identifies the amount of delay required for non-critical signal that is equal to the transition time of the signal on the critical path (350). The process then uses the detection circuit at the sampling point (360). Next the process routes the detection pulse to adjacent non-critical signals to delay the non-critical signals (370). The process then determines if all the critical paths have been designed (380). If all the critical paths have not been designed, the process proceeds to identify next critical path (310).

Circuit Operation

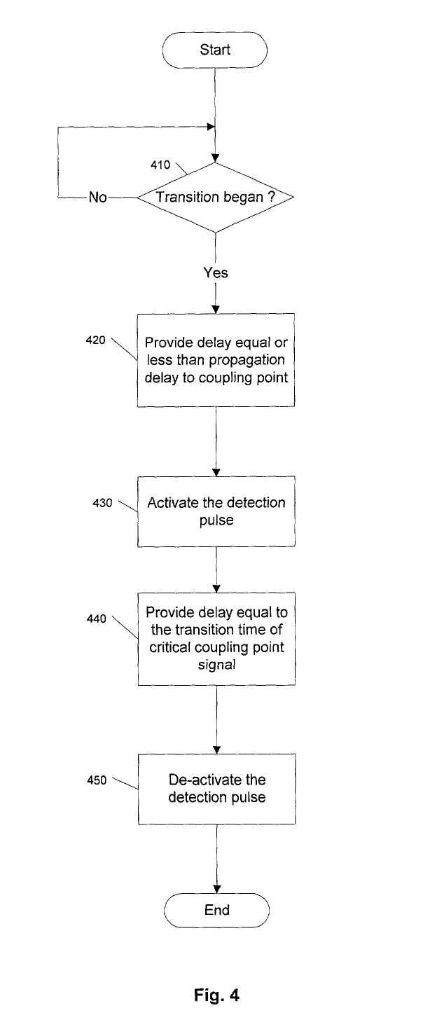

FIG. 4 illustrates an example of steps a circuit performs during a process of zero skew transition detection according to an embodiment of the present invention. The circuit initially determines whether the signal transition on the critical path has begun (410). When the signal transition begins on the critical path, the circuit provides a delay that is equal to or less than the propagation delay of the signal from the sampling point to the coupling point on the critical path (420). The circuit then activates the detection pulse (430). Next, the circuit provides a delay that is equal to the transition time of the signal on the critical path at the coupling point (440). The circuit then de-activates the detection pulse (430).

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. A method of detecting a transition with zero skew comprising:
identifying a coupling point for a plurality of communication paths;
sampling a first communication path of the plurality of communication paths at a sampling point on the first communication path;
detecting transition of a first signal on the first communication path; and
using the transition of the first signal to generate a detection pulse.

2. The method of claim 1, wherein the plurality of communication paths are parallel communication paths.

3. The method of claim 1, wherein the plurality of communication paths are adjacent communication paths.

4. The method of claim 1, wherein the sampling point is located prior to the coupling point on the first communication path.

5. The method of claim 1, wherein the detection pulse is generated by a switching circuit.

6. The method of claim 5, wherein the switching circuit switches with transition of the first signal.

7. The method of claim 1, wherein a plurality of signals simultaneously transition on the plurality of communication paths at the coupling point.

8. The method of claim 1, further comprising:
adjusting the delay of a delay unit to adjust a width of the detection pulse.

9. The method of claim 1, further comprising:
adjusting a first delay for the switching circuit to adjust the width of the detection pulse.

10. The method of claim 1, wherein the width of the detection pulse is equal to a transition period of the first signal.

11. The method of claim 1, further comprising:
using the detection pulse to adjust a second delay in a second signal simultaneously transitioning on at least one of the plurality of communication paths at the coupling point.

12. The method of claim 11, wherein the second delay is equal to the transition period of the first signal.

13. The method of claim 11, wherein the first and the second delays are adjusted by using a plurality of buffers.

14. A system for detecting a transition with zero skew comprising:
a transition detector, the transition detector detects transition of a first signal on a first one of a plurality of communication paths;
a delay unit coupled to the transition detector, the delay unit provides delays for the first signal; and
a switching circuit coupled to the transition detector, the switching unit generates a detection pulse.

15. The system of claim 14, wherein the switching circuit comprises a plurality of metal-oxide field effect transistors.

16. The system of claim 14, wherein the switching circuit switches with transition of the first signal.

17. The system of claim 14, wherein the transition detector is one of the plurality of metal-oxide field effect transistors.

18. The system of claim 14, wherein the delay unit comprises a plurality of buffers.

19. The system of claim 18, wherein a number of the plurality of buffers is adjusted to adjust a width of the detection pulse.

20. The system of claim 15, wherein the width of the detection pulse is equal to a transition period of the first signal.

21. A system of detecting a transition with zero skew comprising:
means for identifying a coupling point for a plurality of communication paths;
means for sampling a first communication path of the plurality of communication paths at a sampling point on the first communication path;
means for detecting transition of a first signal on the first communication path; and
means for using the transition of the first signal to generate a detection pulse.

22. The system of claim 21, wherein the plurality of communication paths are parallel communication paths.

23. The system of claim 21, wherein the plurality of communication paths are adjacent communication paths.

24. The system of claim 21, wherein the sampling point is located prior to the coupling point on the first communication path.

25. The system of claim 21, wherein the detection pulse is generated by a switching circuit.

26. The system of claim 25, wherein the switching circuit switches with transition of the first signal.

27. The system of claim 21, wherein a plurality of signals simultaneously transition on the plurality of communication paths at the coupling point.

28. The system of claim 21, further comprising:
means for adjusting the delay of a delay unit to adjust a width of the detection pulse.

29. The system of claim 21, further comprising:
means for adjusting a first delay for the switching circuit to adjust the width of the detection pulse.

30. The system of claim 21, wherein the width of the detection pulse is equal to a transition period of the first signal.

31. The system of claim 21, further comprising:
means for using the detection pulse to adjust a second delay in a second signal simultaneously transitioning on at least one of the plurality of communication paths at the coupling point.

32. The system of claim 31, wherein the second delay is equal to the transition period of the first signal.

33. The system of claim 31, wherein the first and the second delays are adjusted by using a plurality of buffers.
